(19) United States
(12) Patent Application Publication
(10) Pub. No.: US 2015/0052544 A1
(43) Pub. Date: Feb. 19, 2015

(54) INFORMATION PROCESSING DEVICE, INFORMATION PROCESSING METHOD, INFORMATION PROCESSING SYSTEM, AND COMPUTER PROGRAM PRODUCT

(71) Applicant: Kabushiki Kaisha Toshiba, Minato-ku (JP)

(72) Inventors: Jun KANAI, Inagi (JP); Hiroshi ISOZAKI, Kawasaki (JP)

(73) Assignee: Kabushiki Kaisha Toshiba, Minato-ku (JP)

(21) Appl. No.: 14/457,252

(22) Filed: Aug. 12, 2014

(30) Foreign Application Priority Data
Aug. 15, 2013 (JP) 2013-168936

(51) Int. Cl. H04N 21/422; H04N 21/81; H04N 21/435

(52) U.S. Cl. CPC H04N 21/4222; H04N 21/435; H04N 21/8186
USPC 725/25

(57) ABSTRACT

An application information reader acquires identification information about an application capable of operating an operation target device. An operation application executer executes the application corresponding to the identification information. A device information manager performs authentication with the target device using authentication information, and stores the authentication information when the authentication is successful. A token manager stores a certificate indicating a permission of the operation of the target device. A token receiver requests a token delivery device to generate the certificate corresponding to the authenticated target device; receives the generated certificate; and stores the generated certificate in the token manager. A transmitter transmits, to the target device, a device operation instruction requested from the executed application, the authentication information, and the certificate.

### CROSS-REFERENCE TO RELATED APPLICATION(S)

This application is based upon and claims the benefit of priority from Japanese Patent Application No. 2013-168936, filed on Aug. 15, 2013; the entire contents of which are incorporated herein by reference.

### FIELD

Embodiments described herein relate generally to an information processing device, an information processing method, an information processing system, and a computer program product.

### BACKGROUND

Techniques have become increasingly popular in which operation. target devices such as digital televisions are controlled by operation terminals such as tablets or smartphones through networks. Such remote control is generally allowed to be performed by only terminals that users of the operation target devices such as digital televisions have. There is, however, a need to operate the operation target devices such as digital televisions by in-store terminals such as point of sales (POS) terminals or information terminals installed in stores.

No solution has been provided that enables the operation target devices to be operated by the in-store terminals through the operation terminals in an above manner. Particularly in such cooperative operation, security also needs to be taken into consideration. For example, the operation target devices need to be prevented from being operated in an unauthorized manner.

### BRIEF DESCRIPTION OF THE DRAWINGS

FIG. 1 is a block diagram illustrating an overall structure of an information processing system according to a first embodiment;

FIG. 2 is a block diagram illustrating the detailed overall structure of the information processing system in the first embodiment;

FIG. 3 is a data structure diagram of a token returned from a token provider in the first embodiment;

FIG. 4 is a table of additional information corresponding to an identifier of an application in the first embodiment;

FIG. 5 is a table in which identifier information about an operation target device, and a secret key and a public key for the operation target device are associated with each other for each operation target device;

FIG. 6 is a flowchart illustrating a process flow when authentication of the operation target device is performed in the first embodiment;

FIG. 7 is a flowchart of processing when a token for operating the operation target device is generated in the first embodiment;

FIG. 8 is a flowchart illustrating a process flow of token verification and the operation of the operation target device in the first embodiment;

FIG. 9 is a block diagram illustrating the overall structure of the information processing system according to a first modification of the first embodiment;

FIG. 10 is a flowchart of processing when the token is generated in the first modification of the first embodiment;

FIG. 11 is a flowchart of processing of the token verification and the operation of the operation target device in the first modification of the first embodiment;

FIG. 12 is a block diagram illustrating the detailed overall structure of the information processing system according to a second embodiment;

FIG. 13 is a table illustrating a format when the identifier information about an application information providing device is stored therein in the second embodiment;

FIG. 14 is a flowchart of processing when the token is generated in the second embodiment;

FIG. 15 is a block diagram illustrating the detailed overall structure of the information processing system according to a third embodiment;

FIG. 16 is a flowchart of processing when the token is generated in the third embodiment; and

FIG. 17 is a schematic diagram illustrating an example of a hardware structure of the operating unit in the first to the third embodiments and the first modification.

### DETAILED DESCRIPTION

According to an embodiment, an information processing device includes an application information reader, an operation application executer, a device information manager, a token manager, a token receiver, and a transmitter. The application information reader acquires identification information about an application capable of operating an operation target device. The operation application executer executes the application corresponding to the identification information. The device information manager performs authentication with the operation target device using authentication information, and stores therein the authentication information when the authentication is successful. The token manager stores therein a certificate that is issued for the operation target device and that indicates a permission of the operation of the operation target device. The token receiver requests a token delivery device to generate the certificate corresponding to the authenticated operation target device, when the authentication by the device information manager is successful; receives the generated certificate; and stores the generated in the token manager. The transmitter transmits, to the operation target device, a device operation instruction requested from the executed application, the authentication information acquired from the device information manager, and the certificate acquired from the token manager.

### First Embodiment

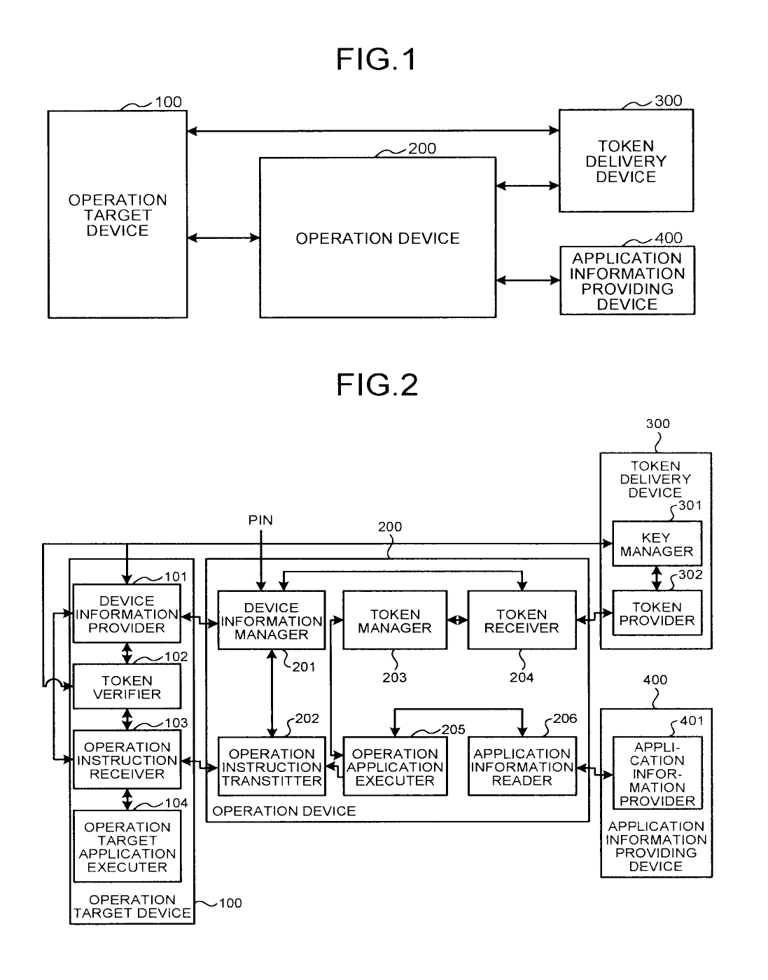

An information operation system according to a first embodiment will be described in detail below with reference to the accompanying drawings. FIG. 1 is a block diagram schematically illustrating the whole of a system. As illustrated in FIG. 1, the information processing system includes an operation target device 100, an operation device 200, an application information providing device 400, and a token delivery device 300. The operation target device 100 is a device that is controlled by the application information providing device 400 through the operation device 200. The operation target device 100 is a stationary device, such as a digital television installed in a home, for example. The operation device 200 is a device that controls the operation target device 100 in accordance with an instruction from the application information providing device 400. The operation device 200 is a portable device, such as a tablet terminal or a smartphone, for example. The application information providing device 400 is a device (terminal) that controls the operation target device 100 through the operation device 200. The application information providing device 400 is a terminal managed by a business entity, such as a point of sales (POS) terminal or a kiosk terminal, for example. The token delivery device 300 is a server on the Internet, for example. The respective devices are connected to each other through a network, such as the Internet, or a near field wireless system, such as an infrared communication, a Bluetooth (registered trademark) system, or a near field communication (NFC), and can communicate with each other. Any communication scheme that connects the respective devices can be used, as long as the devices can communicate with each other.

The application information providing device 400 transmits, to the operation device 200, information for identifying an application executed by the operation device 200. The application may be an application described using a web technique, such as a hyper text markup language (HTML), or a native application compiled into a machine language. The information for identifying the application may be information that can uniquely identify the application. For example, the information may be an executable file name of the application stored in the operation device 200 or a uniform resource locator (URL) of the application described using a web technique.

The operation device 200 executes the application corresponding to the information for identifying the application instructed by the application information providing device 400. The operation device 200 operates the operation target device 100 in accordance with the description of the application. For example, the operation device 200 may transmit, to the operation target device 100, an instruction of video recording reservation or an execution instruction to execute an application. The operation device 200 transmits, to the operation target device 100, a certificate, and a personal identification number (PIN) together with a device operation instruction. The certificate, which is called a token, indicates the permission for operation of the operation target device and is issued for each application and for each operation target. device 100. The PIN is a password unique to the operation target device 100. The PIN corresponds to the authentication information. The operation device 200 acquires the token from the token delivery device 300 and preliminarily authenticates the operation target device 100 using the PIN that an operator of the operation device 200 inputs. As a result, the operation device 200 can determine whether the authentication is completed.

The operation target device 100 receives the device operation instruction, the token, and the PIN, and executes an operation according to the device operation instruction only when the token and the PIN are valid. The operation target device 100 acquires a public key of the token unique to the operation target device 100 from the token delivery device 300 and verifies a signature of the token to verify the validity of the token. The operation target device 100 verifies whether the received PIN is coincident with the PIN set for itself. The verification of the token can confirm that the device operation instruction is operated by the application authorized to operate the operation target device 100. When the PIN is correct, it can be confirmed that the operator of the operation device 20 has input the correct PIN. Thus, the verification of the PIN can confirm that the operator of the operation device 200 permits the operation to be performed on the operation target device 100.

The token delivery device 300 has a function of issuing the token in accordance with a request from the operation device 200 to issue the token. The token is signed with a key (secret key) prepared for each operation target device 100 for the purpose of preventing falsification of the token. The token delivery device 300 transmits, to the operation target device 100, the public key corresponding to the secret key with which the token is signed for verifying the validity of the token.

The operation device 200 executes the application including the device operation instruction in accordance with the instruction form application information providing device 400 and transmits the device operation instruction to the operation target device 100. As a result, the application information providing device 400 can indirectly operate the operation target device 100. Meanwhile, the use of the token and the PIN can prevent the operation target device 100 from being operated in an unauthorized manner.

FIG. 2 is a block diagram illustrating the detailed overall structure of the information processing system in the first embodiment. As illustrated in FIG. 2, the operation target device 100 includes a device information provider 101, a token verifier 102, an operation instruction receiver 103, and an operation target application executer 104. The device information provider 101 performs authentication with the operation device 200. The token verifier 102 verifies the token sent together with the device operation instruction. The operation instruction receiver 103 receives the device operation instruction from the operation device 200. The operation target application executer 104 executes the application.

The device information provider 101 performs the authentication in accordance with a request from a device information manager 201 of the operation device 200. The device information provider 101 performs authentication on whether the PIN sent from the device information manager 201 is correct. As for a method to perform the authentication on whether the PIN is correct, a known method may be used. For example, a challenge & response system may be used in which the device information provider 101 randomly generates values called “challenges” and sends them to the operation device 200; and then the device information manager 201 generates responses (hash values) from the received challenges and PIN information input by a user and returns the generated responses to the device information provider 101. When the authentication is successful, the device information provider 101 notifies the device information manager 201 that the authentication has been completed normally. When the authentication is unsuccessful, the device information provider 101 notifies the device information manager 201 that the authentication has been ended abnormally.

The token verifier 102 determines whether the token sent from the operation device 200 is valid. The token verifier 102 sends an identifier of the operation target device 100 to a key manager 301 of the token delivery device 300 and acquires the public key used when the corresponding token is generated. The token verifier 102 determines using the public key whether the token is correctly signed with the corresponding secret key. When the token is correctly signed, the token verifier 102 replies the successful completion of the signature verification. When an abnormality, such as a falsification, is detected, the token verifier 102 replies an error. The token verifier 102 may not acquire the public key from the token delivery device 300 at every verification, but may store the acquired public key.

The operation instruction receiver 103 receives the device operation instruction to operate the function of the operation target device 100 and executes the operation according to the device operation instruction. The operation instruction is the instruction to operate the operation target device. When the operation target device is a digital television, examples of the operation instruction include activation of an application, channel switching, viewing reservations, and recording reservations. The device operation instruction is executed only when the token and the PIN for operating the operation target device 100 are received from the operation origin (operation device 200) and the device information provider 101 and the token verifier 102 determine that the token and the PIN are valid. Particularly, when the operation instruction is the instruction to execute an application, the operation instruction receiver 103 sends an identifier of the application (also referred to as the application identifier) to be executed to the operation target application executer 104 and requests the operation target application executer 104 to execute the application.

The operation target application executer 104 receives the application identifier from the operation instruction receiver 103 and executes the application. The application displays a commercial message or a questionnaire, for example. The application may be written using a web technique, such as an HTML or a JavaScript (registered trademark), may be compiled into an intermediate language such as a Java (registered trademark) language, or a native application compiled into a machine language from a C language. Upon receiving the application identifier from the operation instruction receiver 103, the operation target application executer 104 determines the corresponding application and executes the application.

Explained below is the operation device 200. The operation device 200 includes a device information manager 201, an operation instruction transmitter 202, a token manager 203, a token receiver 204, an operation application executer 205, and an application information reader 206. The device information manager 201 performs authentication with the operation target device 100 using the PIN. The token manager 203 transmits a request to generate the token, stores therein the generated token, and transmits the stored token. Only when the authentication of the operation target device 100 is completed, the token receiver 204 requests the generation of the token corresponding to the authenticated operation target device 100, the authentication of which is completed, and receives the generated token. The operation application executer 205 executes the application to operate the operation target device 100. The application information reader 206 reads the information for identifying the application (also referred to as the application information) from the application information providing device 400. The operation instruction transmitter 202 transmits the device operation instruction.

The device information manager 201 performs authentication with the operation target device 100. The device information manager 201 receives the PIN information input by a user and stores therein the input PIN. When performing the authentication, the device information manager 201 transmits an authentication request to the device information provider 101 and performs the authentication on the basis of the input PIN information. When the authentication is successful, the device information manager 201 stores therein the PIN information in association with an identifier of the operation target device 100. As for the identifier of the operation target device 100, any information that can uniquely identify the operation target device 100, such as a media access control (MAC) address of the operation target device 100, may be used. The device information manager 201 replies to an inquiry about whether the authentication of the operation target device 100 is completed. When the authentication is completed, the device information manager 201 returns identification information about the operation target device 100, the authentication of which is completed, as a reply to the inquiry. The identification information is the identifier information or the PIN information that has successfully authenticated the PIN. When the authentication is not completed yet, the device information manager 201 returns information indicating that the authentication has not been completed, as a reply to the inquiry.

The token manager 203 receives the request to generate the token from the operation application executer 205, sends the token generation request, and stores therein the generated token. In order to generate the token, the token manager 203 sends the token generation request to the token receiver 204 together with the identifier of the application for which the token is generated. When it is determined that the token is generated, the token manager 203 receives the token from the token receiver 204 and stores therein the generated token. When the token receiver 204 rejects the generation request of the token, the token manager 203 returns an error to the operation application executer 205. The token manager 203 sends the stored token by a token acquisition request. The token is generated for each application. When receiving the token acquisition request From the operation application executer 205, the token manager 203 sends the token for the application to the operation application executer 205. When no corresponding token is stored, the token manager 203 returns an error to the operation application executer 205.

The token receiver 204 receives the token generation request together with the identifier of the application for which the token is generated, and determines whether the token receiver 204 generates the token. The determination is performed as follows. The token receiver 204 inquiries of the device information manager 201 whether the authentication of the operation target device 100 is completed. When the authentication is completed, the token receiver 204 receives the identifier of the operation target device 100, the authentication of which is completed, and transmits the identifiers of the operation target device 100 and the application to a token provider 302 of the token delivery device 300 as the token generation request. When the token is successfully generated, the token receiver 204 returns the token to a requester. When the token provider 302 rejects the generation of the token, the token receiver 204 returns an error to the token manager 203 which is the requester. The token receiver 204 also returns an error to the requester when the authentication has not been completed yet.

The application information reader 206 reads the application information from the application information providing device 400. The application information may be read through a wireless fidelity (Wi-Fi) network, using a QR code (registered trademark), an infrared communication, or a near field wireless communication such as the NFC. When reading the application information, the application information reader 206 receives execution confirmation input. from a user and reads the application information only when the user permits the reading of the application information. After reading the application information, the application information reader 206 requests the operation application executer 205 to execute the application corresponding to the reading application information.

The operation application executer 205 receives the application activation request and executes the application. The operation application executer 205 requests the token manager 203 to generate or acquire the token according to the instruction of the application. The operation application executer 205 sends the operation instruction and the token acquired from the token manager 203 to the operation instruction transmitter 202 and requests the operation instruction transmitter 202 to transmit the operation instruction to the operation target device 100.

The operation instruction transmitter 202 transmits the device operation instruction to the operation instruction receiver 103 of the operation target device 100 in accordance with the request from the operation application executer 205. Meanwhile, the operation instruction transmitter 202 receives the token from the operation application executer 205 of the operation device 200, and transmits the received token to the operation target device 100. The operation instruction transmitter 202 sends the information about the identifier of the operation target device 100 to the device information manager 201, acquires the corresponding PIN information, and transmits the token with the PIN information.

The application information providing device 400 includes an application information provider 401 that provides the operation device 200 with the application information about the application to be executed. The application information provider 401 provides the application information reader 206 with the information about the identifier of the application to be executed in the operation device 200. The application may be an application that executes a commercial message display application in the operation target device 100 or an application that executes a questionnaire application in the operation target device 100, for example.

The token delivery device 300 includes a key manager 301 that stores therein the secret key and the public key to generate the token in a public key cryptography system; and the token provider 302 that receives the token generation request and generates the token. The key for signing the token is prepared for each operation target device 100.

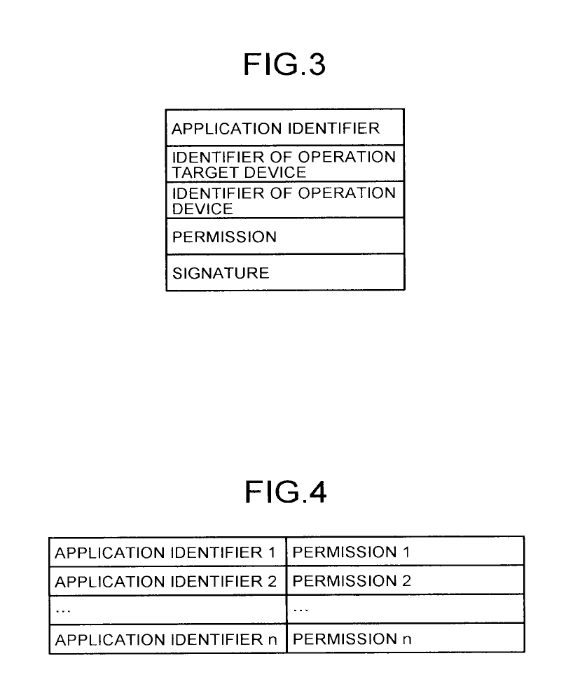

The token provider 302 receives, from the token receiver 204, the identifier of the application for which the token is generated, the identifier information about the operation target device 100 to be operated (serving as the operation target), and the identifier information about the operation device 200 as the token generation request. The token provider 302 further acquires additional information corresponding to the identifier of the application from the table illustrated in FIG. 4, signs them to generate the token, and returns the token having the structure illustrated in FIG. 3 to the token receiver 204. The token provider 302 manages the table illustrated in FIG. 4, in which the application identifier and the additional information about the application are associated with each other. In FIG. 3, the additional information is permission information. As the additional information, version information about the application may be used. The token provider 302 sends the identifier information about the operation target device 100 to the key manager 301, and acquires the corresponding secret key for signing the token. The token provider 302 signs the token using the acquired secret key. As for the signing algorithm, a system according to a widely known public key system such as a Rivest-Shamir-Adleman (RSA) system may be used.

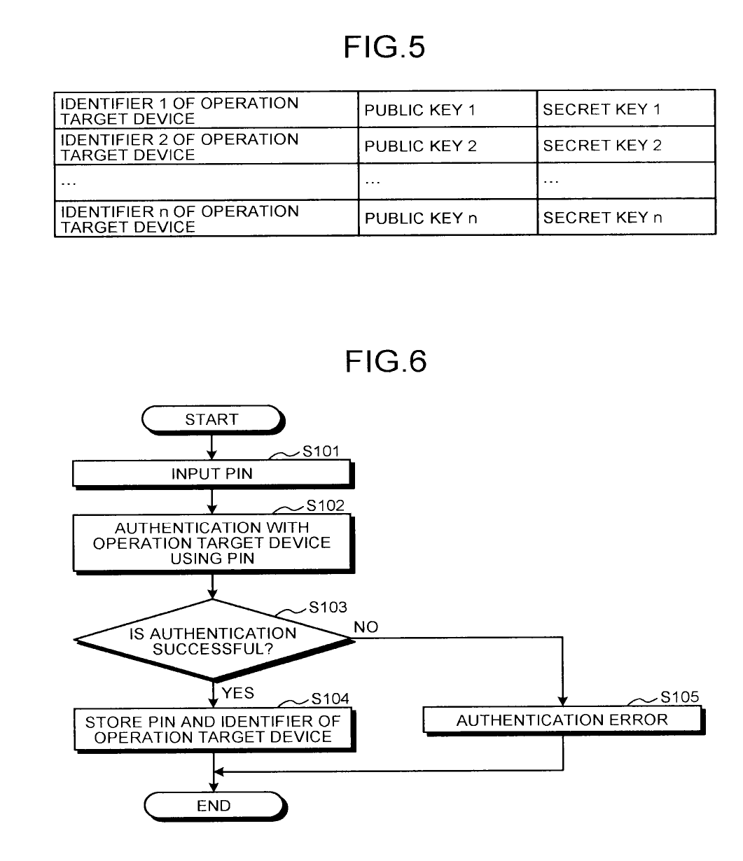

The key manager 301 stores therein a list illustrated in FIG. 5, in which the identifier information about the operation target device 100, and the secret key and the public key for the operation target device 100 are associated with each other. The key manager 301 receives, from the token verifier 102 or the device information provider 101, the identifier information about the operation target device 100 the public key that is to be acquired, and returns the corresponding public key included in the table of FIG. 5. For example, when receiving an identifier 2 of the operation target device 100 as the identifier information, the key manager 301 returns a public key 2. The key manager 301 receives, from the token provider 302, the identifier information about the operation target device 100 the secret key that is to be acquired, and returns the corresponding secret key included in the table of FIG. 5. For example, when receiving an identifier 1 of the operation target device 100 as the identifier information, the key manager 301 returns a secret key 1.

The following describes a process flow when the authentication is performed between the device information manager 201 and the operation target device 100 with reference to the flowchart illustrated in FIG. 6. The device information manager 201 requests a user to input the PIN and the user inputs the PIN (step S101). The device information manager 201 requests the device information provider 101 to perform the authentication. The device information provider 101 and the device information manager 201 perform the authentication using the input PIN (step S102). The device information provider 101 returns the information indicating whether the authentication is successful or unsuccessful to the device information manager 201. The device information manager 201 determines whether the authentication is successful from the received information (step S103). If it is determined that the authentication is successful (Yes at step S103), the device information manager 201 stores therein the input PIN code together with the identifier of the operation target device 100 (step S104) and thereafter the authentication ends. If it is determined that the authentication is unsuccessful (No at step S103), then it is an authentication error (step S105). In this case, the input PIN is not stored.

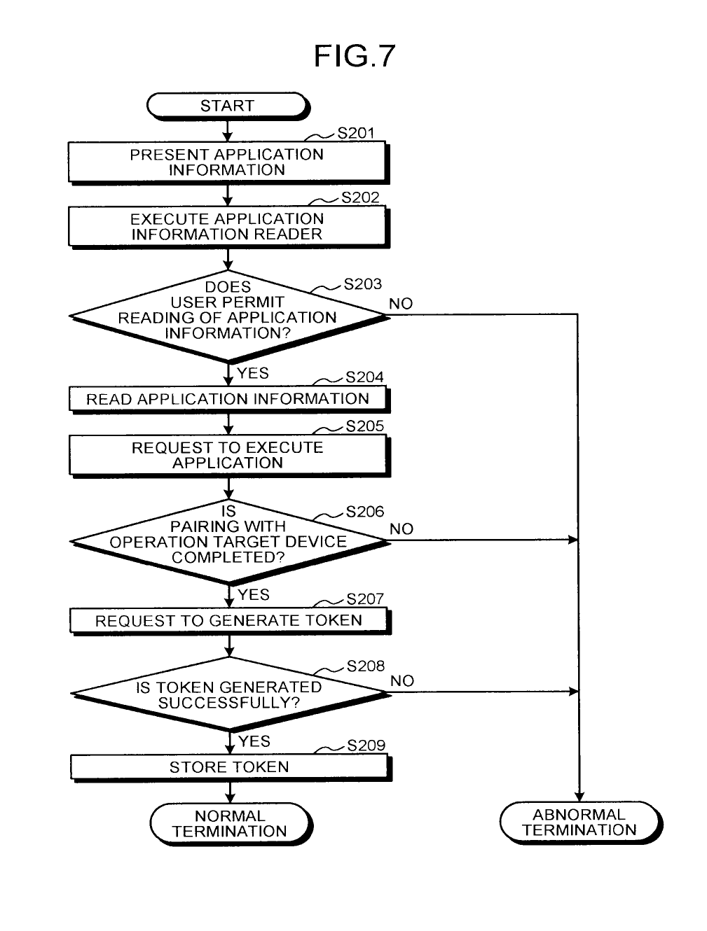

The following describes a process flow when the application information is read and the token for operating the operation target device 100 is generated, with reference to FIG. 7. This process is performed when a user makes payment at a store and the application information is read, for example. In accordance with an explicit application activation request from an operator of the application information providing device 400, for example, the application information provider 401 presents the application information on a screen of a terminal, for example (step S201). Subsequently, in accordance with an explicit application activation request from an operator (user) of the operation device 200, for example, the application information reader 206 is executed (step S202). The application information reader 206 may be automatically executed when the operation device 200 is executed and may consistently run during the operation. of the operation device 200. The application information reader 206 determines whether the user permits the reading of the application information (step S203). In the determination, a dialog screen is explicitly presented to the user and prompts the user to select permission or rejection, for example. When the user explicitly executes the application information reader 206, the process at step S203 is dispensable because the action of the user can be deemed that the user agrees with the reading of the application.

If the user rejects the reading of the application information (No at step S203), the process flow ends as an abnormal termination. If the user permits the reading of the application information (Yes at step S203), the application information reader 206 reads the application information (step S204). The application information may be read through a Wi-Fi network, or using the QR code (registered trademark), an infrared communication, or a near field wireless communication such as the NEC.

The application information reader 206 sends the reading application information to the operation application executer 205 and requests the operation application executer 205 to execute the application (step S205). After activating the corresponding application, the operation application executer 205 sends the application identifier to the token manager 203 and requests the token manager 203 to generate the token. The token manager 203 sends the application identifier to the token receiver 204 and requests the token receiver 204 to generate the token. The token receiver 204 determines whether the authentication (pairing) is already completed in the sequence illustrated in FIG. 6 on the basis of the fact whether the PIN and the identifier of the operation target device 100 are stored (step S206). If the pairing is completed (Yes at step S206), the token receiver 204 sends the application identifier, the identifier of the operation target device (the identifier of the operation target device 100), and the identifier of the operation device 200 to the token provider 302 and makes a token generation request to the token provider 302 (step S207). If the pairing is not completed (No at step S206), the process flow ends as an abnormal termination.

If the pairing is completed, the token provider 302 acquires the secret key corresponding to the operation target device 10C from the key manager 301, signs the data received from the token receiver 204, and returns the resulting data as a token to the token receiver 204. When an abnormality occurs, such as that no key corresponding to the identifier of the operation target device 100 exists, the token provider 302 returns error information to the token receiver 204. The token receiver 204 sends the data received from the token provider 302 to the token manager 203. The token manager 203 determines whether the token is generated successfully (step S208). If the token is generated successfully (Yes at step S208), the token manager 203 stores the token in a non-volatile area (step S209) and thereafter the process flow ends as a normal termination. If the token is not successfully generated (No at step S208), the process flow ends as an abnormal termination.

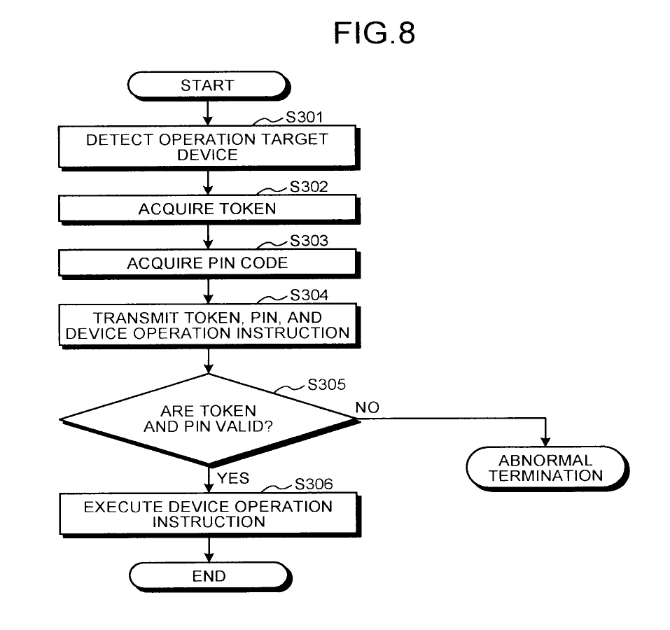

The following describes a process flow when the operation target device is operated, with reference to FIG. 8. Upon detecting the operation target device 100 (step S301), the operation application executer 205 sends the identifier of the operation target device 100 to the token manager 203 and acquires the token stored in accordance with the flow illustrated in FIG. 7 (step S302). The operation application executer 205 sends the acquired token and the device operation instruction to the operation instruction transmitter 202. The operation instruction transmitter 202 sends the identifier of the operation target device 100 to the device information manager 201 and acquires the corresponding PIN code (step S303).

The operation instruction transmitter 202 transmits the token, the acquired PIN code, and the device operation instruction to the operation instruction receiver 103 (step S304). As a communication path, a generally known system may be used such as a wired local area network (LAN), a wireless LAN, an infrared communication, or a near-field wireless communication. The operation instruction receiver 103 sends the received token to the token verifier 102. The token verifier 102 acquires the public key corresponding to the identifier of the operation target device 100 from the key manager 301 through the device information provider 101, verifies the signature information included in the token, and determines whether the PIN code is correct (step S305). If it is determined that the token and the PIN are correct (Yes at step S305), the operation instruction receiver 103 sends the received device operation instruction to the operation target application executer 104. The operation target application executer 104 then executes the device operation instruction (step S306). If it is determined that the token and or the PIN is incorrect (No at step S305), the process flow ends as an abnormal termination and the device operation instruction is not executed.

The first embodiment described above can indirectly operate the operation target device 100 through the operation device 200. For example, the application information providing device 400 can execute the application in the operation target device 100 through the operation device 200. As a result, when the user makes a payment at a store, the first embodiment can cause a program to be executed in an operation target device after a user has returned home. For example, the program displays a commercial message or a questionnaire about a product or a bonus video on a digital television serving as the operation target device 100 after the user has returned home. The first embodiment does not only enable the operation device 200 to control the operation target device 100 securely, but also enables the application information providing device 400 to control the operation target device 100 through the operation device 200. The first embodiment further enables the following operation to be performed. Information about payment and searching on products is accumulated in a mobile phone. The information about payment and searching is transmitted to a digital television. The digital television determines the user's preference on the basis of the information about payment and searching. The digital television displays commercial messages in tune with the user's preference. Furthermore, any operation can be performed on the digital television from a terminal through which the user directly makes payment.

### First Modification

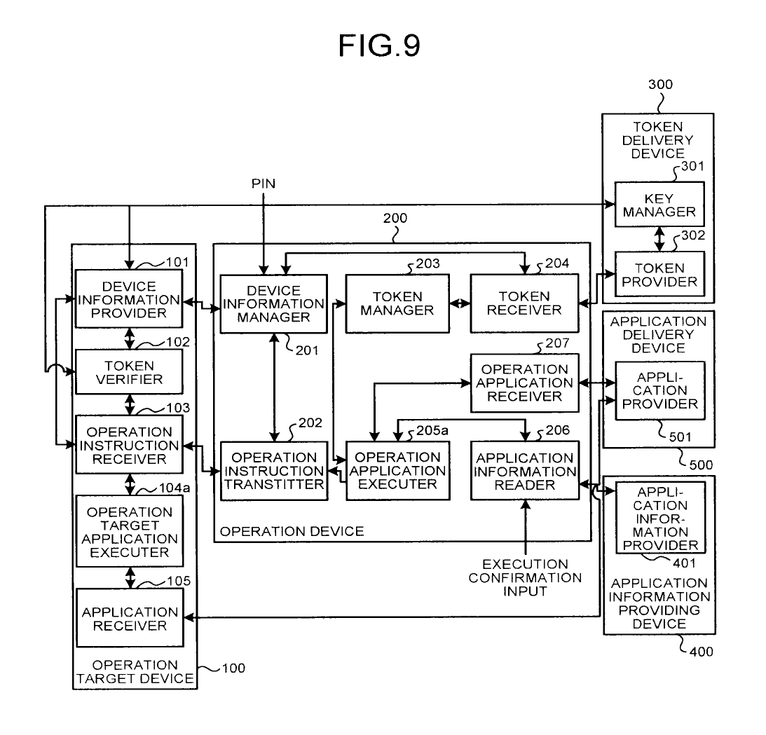

In the structure illustrated in FIG. 2, the application that runs in the operation target device 100 is preliminarily stored in the operation target device 100, while the application that runs in the operation device 200 is preliminarily stored in the operation device 200. In recent applications, some types of applications have become increasingly popular that are automatically downloaded through a network and executed when the applications are requested to be executed. For example, those types are typically used for web applications that are made using web techniques such as HTML or JavaScript. In the structure illustrated in FIG. 9, an application can be dynamically downloaded and executed when the application is requested to be executed. The structure of the information processing system illustrated in FIG. 9 will be described below.

The structure illustrated in FIG. 9 differs from that illustrated in FIG. 2 in that an application delivery device 500 includes an application provider 501; the operation device 200 includes an operation application receiver 207; the operation target device 100 includes an application receiver 105; and the internal processing of an operation application executer 205a and the internal operation of an operation target application executer 104a respectively differ from those of the internal processing of the operation application executer 205 and the operation target application executer 104 in FIG. 2.

The application provider 501 receives the information for identifying the application (application information) and returns the corresponding application data to the operation application receiver 207. For example, when the application is a web application, the application information may be designated with the URL. The application data is a set of pieces of data, such as an HTML, a JavaScript, or a moving image file, when the application is a web application, for example. The application data is an execution file when the application is a native application, for example. The application delivery device 500 may be at a remote location when the operation device 200 and the application delivery device 500 are connected to each other through a network such as the Internet.

The operation application receiver 207 receives the application information and acquires the application data indicated by the application information from the application delivery device 500. For example, when the application is a web application, the application data is acquired using a protocol such as a hyper text transfer protocol (HTTP) or a file transfer protocol (FTP).

In addition to the functions of the operation application executer 205 illustrated in FIG. 2, the operation application executer 205a sends the application information to the operation application receiver 207 and requests the operation application receiver 207 to acquire the application data, when an application is requested to be executed. When the acquisition of the application data is completed, the operation application executer 205a starts the execution of the application.

The operation application receiver 207 receives the application information and acquires the application data indicated by the application information from the application delivery device 500. In addition to the functions of the operation target application executer 104 illustrated in FIG. 2, the operation target application executer 104a sends the application information to the application provider 501 to download the application and executes the downloaded application when the instruction received from the operation instruction receiver 103 is the application activation instruction. The operation application receiver 207 may cache the application data acquired from the application delivery device 500 in a non-volatile area (not illustrated) of the operation device 200 so as to speed up the activation of the application from the second time onwards.

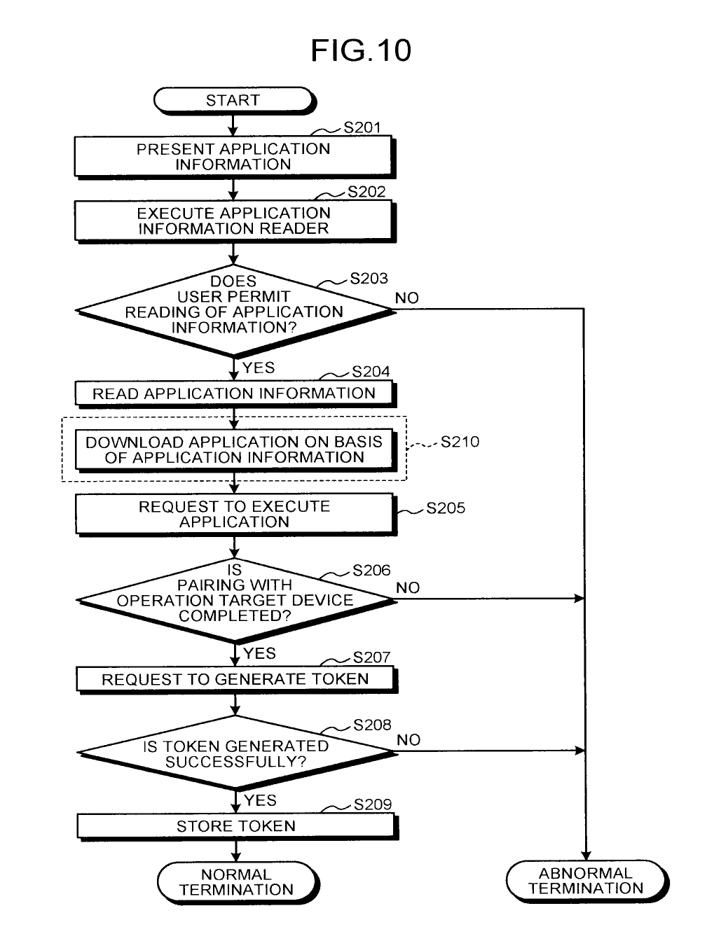

Next, a process flow when the application information is read in the structure illustrated in FIG. 9 will be described with reference to FIG. 10. The flow illustrated in FIG. 10 differs from that illustrated in FIG. 7 in that the process at step S210, which is surrounded with the dotted line, is added. The process at step S210 is described. After reading the application information, the application information reader 206 sends the application information to the operation application executer 205a. The operation application executer 205a sends the application information to the operation application receiver 207. The operation application receiver 207 sends the application information to the application provider 501 and acquires the application data (step S210). Thereafter, the execution of the application starts.

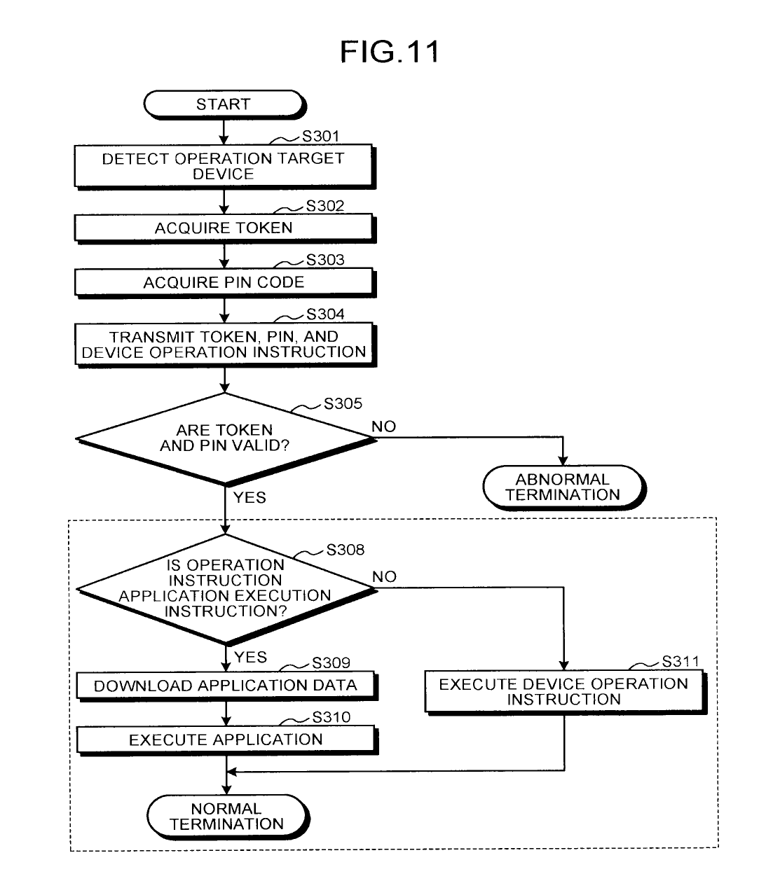

Next, a process flow when the operation target device is operated will be described with reference to FIG. 11. The flow illustrated in FIG. 11 differs from that illustrated in FIG. 8 in that the processes from step S308 to step S311, which is surrounded with the dotted line, is added instead of the process at step S306. The process from step S308 to step S311 is described. After the operation instruction receiver 103 verifies the token and the validity of the PIN (step S305), the operation target application executer 104a is called together with the operation instruction. The operation target application executer 104a determines whether the operation instruction is the application execution instruction (step S308). If the operation instruction is not the application execution instruction (No at step S308), the operation target application executer 104a deems the operation instruction as the normal device operation instruction and executes the designated device operation instruction (step S311), and thereafter the process flow ends. For example, operation instructions other than the application execution instruction include channel switching instructions, video recording instructions, or viewing reservation instructions when the operation target device is a digital television.

If the operation instruction is the application execution instruction (Yes at step S308), the operation target application executer 104a sends the application information included in the device operation instruction to the application receiver 105 and requests the application receiver 105 to acquire the application. The application receiver 105 sends the application information to the application provider 501 to download the application (step S309). Thereafter, the operation target application executer 104a executes the acquired application (step S310), and then the process flow ends.

The first modification of the first embodiment described above enables the operation device 200 and the operation target device 100 to execute various applications, which are not required to be preliminarily installed in the terminal. The first modification is effective when a number of business entities operate the application information providing devices 400, and applications executed in the operation device 200 and the operation target device 100 are individually developed or customized because it is impractical that all of the applications are preliminarily installed.

### Second Embodiment

In the first embodiment, the application information providing device 400, which serves as the terminal of a business entity, cannot verify the validity of the token as well as cannot check whether the pairing with the operation target device 100 is completed. Therefore, the application information providing device 400 cannot check whether the application information providing unit 400 can operate the operation target device 100. When the operation of the operation target device 100 is advantageous for the business entity, it is preferable for the business entity to check whether the business entity can operate the operation target device 100. This applies to a case where a questionnaire or a commercial message of a product sold by the business entity is displayed on the operation target device 100, for example. It is critical in a case where a product is discounted in return for a product buyer to agree to answer a questionnaire or a commercial message to be displayed. A second embodiment enables the application information providing device 400 to check whether the pairing with the operation target device 100 is completed or to verify the validity of the token, thereby making it possible to solve the problem described above. A structure of the second embodiment will be described below in detail.

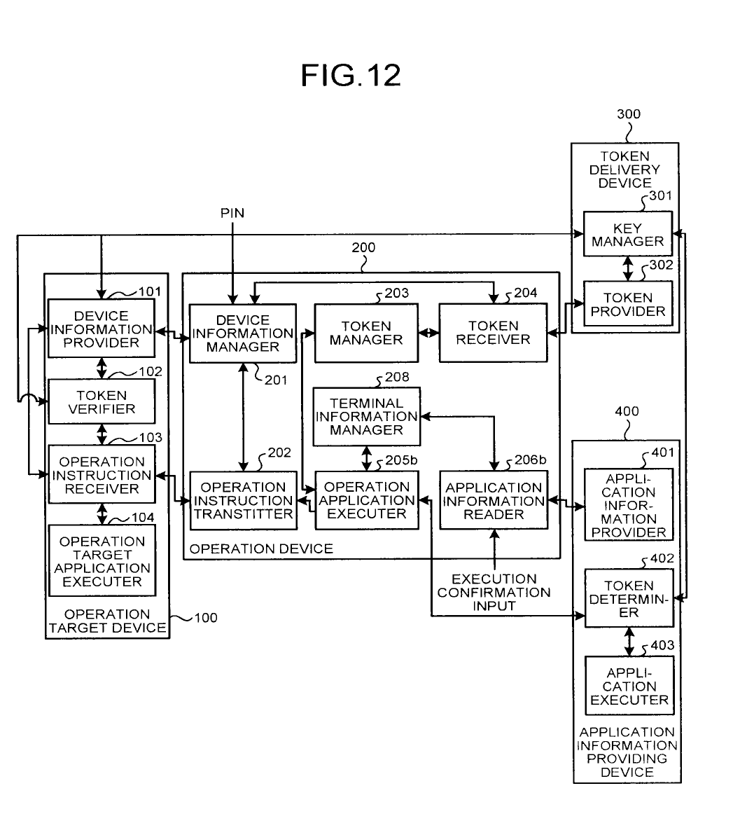

FIG. 12 illustrates an example of the structure of the system in the second embodiment. The second embodiment is described in detail below with reference to FIG. 12. The application information providing device 400 in FIG. 12 differs from that in FIG. 2 in that a token determiner 402 and an application executer 403 are included. The token determiner 402 verifies the validity of the token. As described in the first embodiment, the token receiver 204 has a function of generating the token only when the pairing with the operation target device 100 is completed. Thus, the confirmation of the presence of the valid token makes it possible to confirm that the application information providing device 400 can operate the operation target device 100.

The token determiner 402 receives the token, sends the identifier of the operation target device 100 included in the token to the key manager 301 of the token delivery device 300, and acquires the public key for verifying the signature of the token. The token determiner 402 verifies the signature of the token using the acquired public key. If the signature is correct, the token ensures that the operation target device 100 can be operated. Furthermore, because the token includes the identifier of the operation device 200, it may be checked whether the token is copied from another operation device 200 without being authorized, by determining whether the identifier of the operation device 200 from which the token is transmitted and the identifier information about the operation device 200 included in the token are coincident with each other.

The application executer 403 receives the information indicating whether the token is valid from the token determiner 402, and sends the information to an application to be run in the application information providing device 400. For example, the application is executed by the application executer 403 for making a payment on a product. If the token is valid, the payment is made on the basis of a discounted price while if the token is invalid, the payment is made on the basis of the usual price.

The operation device 200 in FIG. 12 differs from that in FIG. 2 in that a terminal information manager 208 is included, and in that the internal structures of an application information reader 206b and an operation application executer 205b differ from those of the application information reader 206 and the operation application executer 205 in FIG. 2.

The application information reader 206b reads the information for identifying the application (application information) from the application information provider 401. The application information may be read through a Wi-Fi network, or using the QR code, an infrared communication, or a near field wireless communication such as the NFC. When reading the application information, the application information reader 206b receives execution confirmation input from a user and reads the application information only when the user permits the reading of the application information. After reading the application information, the application information reader 206b sends the application identifier and the identifier information about the application information providing device 400 to the terminal information manager 208 and requests the terminal information manager 208 to execute the application corresponding to the application identifier.

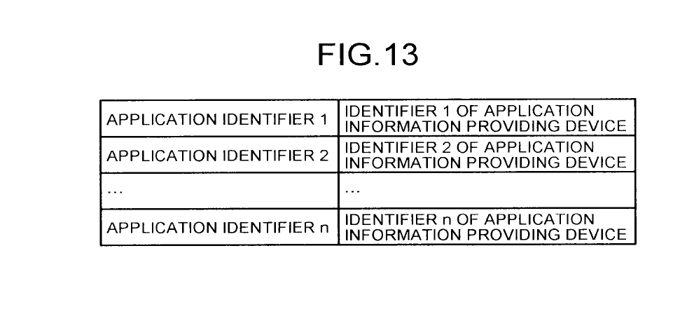

The terminal information manager 208 receives, from the application information reader 206b, the application identifier information and the identifier information about the application information providing device 400 from which the application information is read, sends the application identifier information to the operation application executer 205b, and requests the operation application executer 205b to execute the application. The terminal information manager 208 stores the received identifier information about the application information providing device 400 in the table illustrated in FIG. 13. Furthermore, in response to the request from the operation application executer 205b, the terminal information manager 208 sends, to the operation application executer 205b, the identifier information about the application information providing device 400 from which the application information is read. This is because the operation application executer 205b needs to send token information to the application information providing device 400 from which the application information is read. For example, when the identifier information about the application information providing device 400 from which the application information is read is requested to be read during the execution of the application corresponding to the application identifier 1, the operation application executer 205b returns the identifier 1 to the application information providing device 400.

In addition to the functions of the operation application executer 205 in the first embodiment, the operation application executer 205b sends the acquired token to the token determiner 402. At this time, in order to transmit the token to the application information providing device 400 from which the application information reader 206b reads the application information, the operation application executer 205b receives the identifier information about the application information providing device 400 from the terminal information manager 208 and transmits the token acquired from the token manager 203 to the token determiner 402.

The operation target device 100 in FIG. 12 has the same structure as the operation target device 100 in FIG. 2. The token delivery device 300 in FIG. 12 has almost the same structure as the token delivery device 300 in FIG. 2. The key manager 301 in FIG. 12, however, sends the public key for verifying the token also to the token determiner 402.

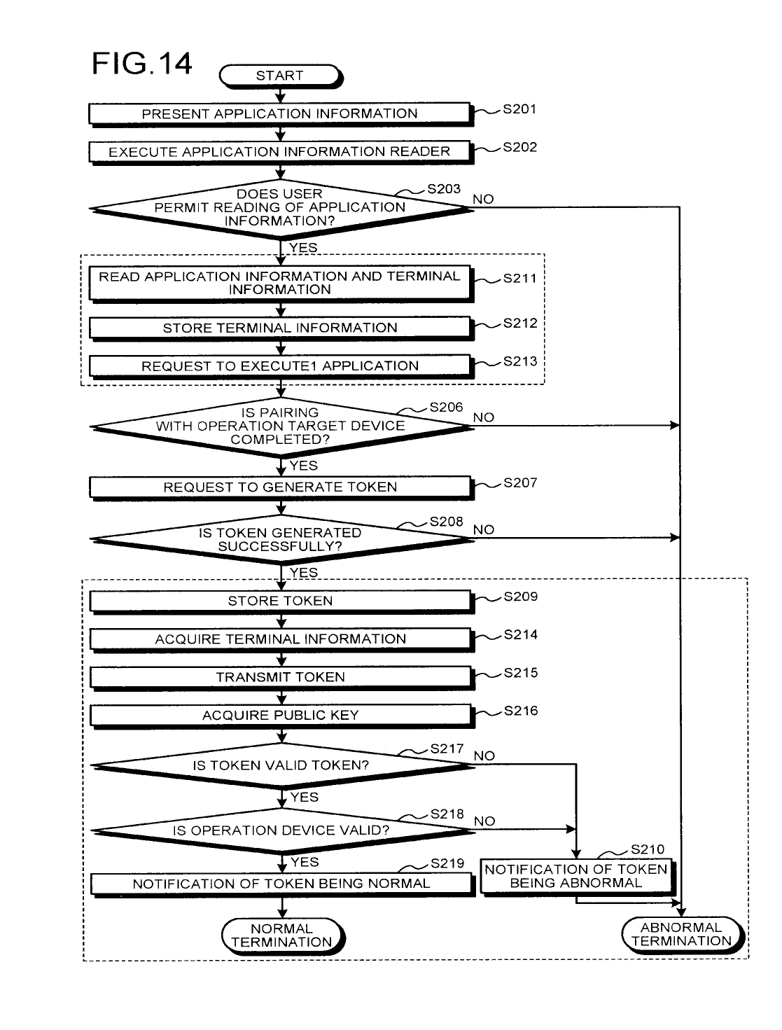

Described below are a process flow when pairing is performed, a process flow after the application information is read, and a process flow when the operation target device 100 is operated in the second embodiment. The process flow of the pairing with the operation target device is the same as that in FIG. 6. The process flow when the operation target device is operated is the same as that in FIG. 8. Here, the process flow after the application information is read is described with reference to FIG. 14.

The process flow in FIG. 14 differs from that in FIG. 7 in that the processes from step S211 to step S213, i.e., from a process where the application is read to a process where the terminal information is stored is included instead of the processes at steps S204 and S205, and the processes from step S209 to step S219, i.e., the process after the token is stored, is included instead of the process after that at step S208. Each process is described below. The application information reader 206b reads the application information and the terminal information about the application information providing device 400 (step S211). The terminal information is used for uniquely identifying the application information providing device 400. For example, when the application information is read through an internet protocol (IP) network, the IP address or the MAC address of the application information providing device 400 may be the terminal information. When a connection is established with the application information providing device 400, the identifier of the connection may be the terminal information. The application information reader 206b sends the reading application information and terminal information to the terminal information manager 208. The terminal information manager 208 stores therein the terminal information in association with the application information (step S212). The terminal information manager 208 sends the application information to the operation application executer 205b and requests the operation application executer 205b to execute the corresponding application (step S213).

If it is determined that the token is successfully generated (Yes at step S208), the token manager 203 stores therein the token (step S209). The operation application executer 205b sends the application information to the terminal information manager 208. The terminal information manager 208 acquires, from the information stored at step S212, the terminal information corresponding to the received application information and returns the terminal information to the operation application executer 205b (step S214). The operation application executer 205b transmits the token to the token determiner 402 of the application information providing device 400 corresponding to the terminal information (step S215).

The token determiner 402 sends the identifier of the operation target device 100 included in the token to the key manager 301 of the token delivery device 300. The key manager 301 returns, to the token determiner 402, the public key for verifying the signature of the token corresponding to the identifier of the operation target device 100 (step S216). The token determiner 402 verifies the signature included in the token using the acquired public key and determines whether the token is a valid token (step S217). If the token is an invalid token (No at step S217), the token determiner 402 notifies the operation application executer 205b of the token being abnormal (step S210), and thereafter the process flow ends as an abnormal termination.

If the token is the valid token (Yes at step S217), the token determiner 402 determines whether the operation device 200 is valid on the basis of the fact whether the identifier of the operation device 200 included in the token and the identifier of the operation device 200 from which the token is transmitted. are coincident with each other (step S218). If the operation device 200 is valid (Yes at step S218), the token determiner 402 notifies the operation application executer 205b of the token being normal (step S219) and thereafter the process flow ends as a normal termination. If the operation device 200 is invalid (No at step S218), the token determiner 402 notifies the operation application executer 205b of the token being abnormal (step S210) and thereafter the process flow ends as an abnormal termination.

The information processing system in the second embodiment enables the application information providing device 400 to verify the validity of the token and to check whether the application information providing device 400 can operate the operation target device 100 on the basis of the received token. As a result, the second embodiment enables the following exemplary operations to be performed. When a user makes a payment on a product at a store, the product is discounted using a POS register, which is an example of the application information providing device 400, if the process flow illustrated in FIG. 14 is ended as a normal termination, in return for a user's guarantee to accept a program to be executed that displays a commercial message or a questionnaire of the product on a digital television serving as the operation target device 100 after the user returns home.

### Third Embodiment

In the second embodiment, the operation of the operation target device 100 is advantageous to the business entity. in such a case, the application information providing device 400, which is the terminal of the business entity, needs to be capable of checking whether the token stored in the operation device 200 is valid. There is, however, also a case where the operation target device 100 being operated is advantageous to a user. An example of such a case is a case where a bonus video is displayed on a digital television serving as the operation target device 100 in return for buying a product. For example, in such a case, if a user can generate the token without buying the product, the user can watch the bonus video in an unauthorized manner by installing the application executed by the operation device 200 in the operation device 200 and executing the application. A third embodiment enables a function of generating the token to be provided only when the generation of the token is permitted by the business entity. As a result, it is difficult for the product buyer to watch the bonus video without being authorized, thereby making it possible to protect the business entity from being subject to unauthorized activities.

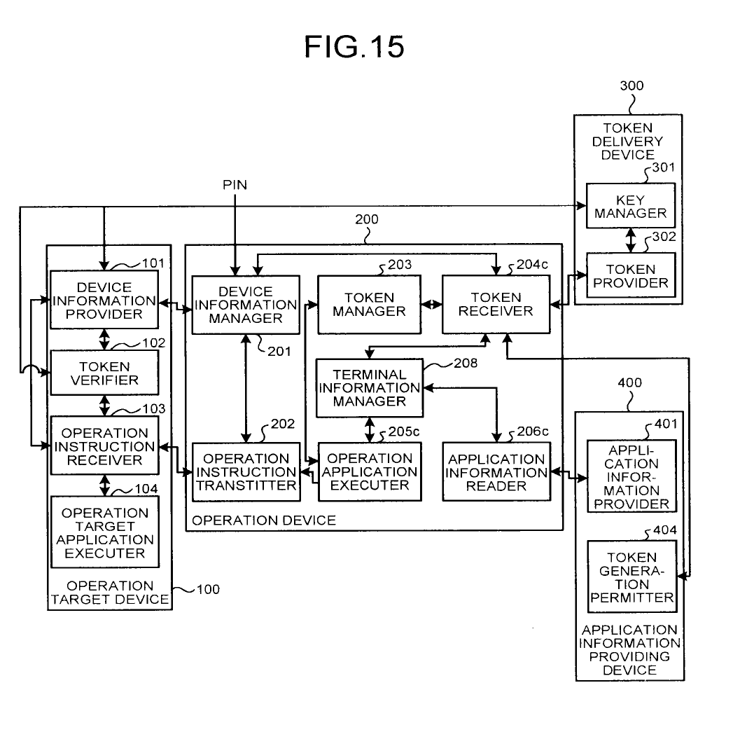

FIG. 15 illustrates an example of the structure of the system in the third embodiment. The third embodiment is described in detail below with reference to FIG. 15. The application information providing device 400 in FIG. 15 differs from that in FIG. 2 in that a token generation permitter 404 is included. The token generation permitter 404 receives the identifier of the operation device 200, determines whether permission is given for producing the token, and conveys the determination result to a token receiver 204c. The determination may be made by performing a confirmation whether the application information is surely transmitted to the identifier of the operation device 200 on the basis of the identifier of the operation device 200, for example. When the application information providing device 400 is a FOS terminal, the generation of the token is permitted only for a user who buys a product by checking whether the terminal identifier is the identifier of the terminal that handles the user's buying of the product. As described above, the operation device 200 can acquire the token only when the token generation permitter 404 permits the generation of the token, thereby making it difficult for the user to acquire the token in an unauthorized manner.

The operation device 200 in FIG. 15 differs from that in FIG. 2 in that the terminal information manager 208 is included and the internal structures of an application information reader 206c, an operation application executer 205c, and the token receiver 204c respectively differ from those of the application information reader 206, the operation application executer 205, and the token receiver 204 in FIG. 2.

The application information reader 206c reads the information for identifying the application (application information) from the application information provider 401. The application information may be read through a Wi-Fi network, or using the QR code, an infrared communication, or a near field wireless communication such as the NFC. When reading the application information, the application information reader 206c receives execution confirmation input from a user and reads the application information only when the user permits the reading of the application information. After reading the application information, the application information reader 206c sends the application identifier and the identifier information about the application information providing device 400 to the terminal information manager 208 and requests the terminal information manager 208 to execute the corresponding application.

The terminal information manager 208 receives, from the application information reader 206c, the application identifier information and the identifier information about the application information providing device 400 from which the application information is read, sends the application identifier information to the operation application executer 205c, and requests the operation application executer 205c to execute the application. The terminal information manager 208 stores the received identifier information about the application information providing device 400. Furthermore, in response to the request from the token receiver 204c, the terminal information manager 208 sends, to the operation application executer 205c, the identifier information about the application information providing device 400 from which the application information is read. This is because the token receiver 204c needs to check with the application information providing device 400, from which the application information is read, whether the generation of the token is permitted.

In the first embodiment, the operation application executer 205 receives the identifier of the application from the application information reader 206c. In the third embodiment, the operation application executer 205c receives the identifier of the application from the terminal information manager 208, which differs from the structure in FIG. 2 in the first embodiment. The token receiver 204c receives the token generation request together with the identifier of the application for which the token is generated, and determines whether the token receiver 204 generates the token. In the first embodiment, the determination is made as follows: the device information manager 201 is checked whether the authentication of the operation target device 100 is completed, and when the authentication is completed, the token generation request. is made. In the third embodiment, the identifier information about the application information providing device 400 from which the application information is transmitted, is checked against the terminal information manager 208, and based on this identifier information the token generation permitter 404 of the corresponding application information providing device 400 is checked whether the generation of the token is permitted. Only when the generation of the token is permitted and the authentication of the operation target device 100 is completed, the token generation instruction is transmitted to the token provider 302. When the token is successfully generated, the token receiver 204c returns the token to the requester. When the token provider 302 rejects the generation of the token, the token receiver 204c returns an error to the calling origin. When the authentication is not yet completed or the token provider 302 rejects the generation of the token, the token receiver 204c returns an error to the requester.

The token generation permitter 404 receives a request to determine whether the generation of the token is permitted from the token receiver 204c and returns the determination result to the token receiver 204c. The determination may be performed on the basis of the following exemplary condition. After receiving the determination request, the token generation permitter 404 determines whether the payment on the product is made and permits the generation of the token only when the payment is made. As a result, the operation device 200 can receive the token only when the payment is made.

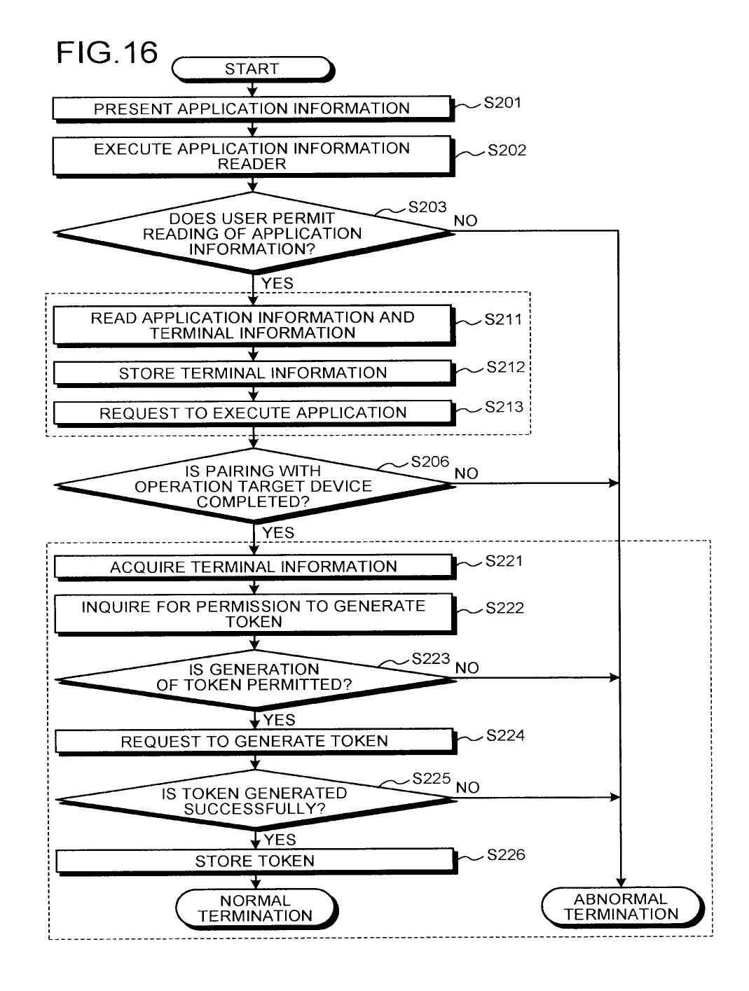

Described below are a process flow when the pairing is performed, a process flow after the application information is read, and a process flow when the operation target device 100 is operated in the third embodiment. The process flow of the pairing with the operation target device is the same as that in FIG. 6. The process flow when the operation target device is operated is the same as that in FIG. 8. The process flow after the application information is read is described below with reference to FIG. 16.

The process flow in FIG. 16 differs from that in FIG. 7 in that the processes from step S211 to step S213, i.e., from a process where the application is read to a process where the terminal information is stored, is included instead of the processes at steps S204 and S205 and the processes from step S221 to step S226, i.e., the process after the terminal information is acquired, is included instead of the process after the process at step S208. Each process is described below.

The application information reader 206c reads the application information and the terminal information about the application information providing device 400 (step S211). The terminal information is used for uniquely identifying the application information providing device 400. For example, when the application information is read through an IP network, the IP address or the MAC address of the application information providing device 400 may be the terminal information. When a connection is established with the application information providing device 400, the identifier of the connection may be the terminal information. The application information reader 206c sends the read application information and terminal information to the terminal information manager 208. The terminal information manager 208 stores therein the terminal information in association with the application information (step S212). The terminal information manager 208 sends the application information to the operation application executer 205c and requests the operation application executer 205c to execute the application (step S213).

If the pairing with the operation target device is completed (Yes at step S206), the token receiver 204c sends the application information to the terminal information manager 208 after checking whether the pairing with the operation target device is completed. The terminal information manager 208 acquires, from the information stored at step S212, the terminal information corresponding to the received application information and returns the acquired terminal information to the token generator 204c (step S221). The token receiver 204c sends the identifier information about the operation device 200 to the token generation permitter 404 of the application information providing device 400 corresponding to the acquired terminal information and receives the information indicating whether the generation of the token is permitted (step S222). If the generation of the token is not permitted (No at step S223), the process flow ends as an abnormal termination. If the generation of the token is permitted (Yes at step S223), the token receiver 204c sends the application identifier, the identifier of the operation target device (the operation target device 100), and the identifier of the operation device 200 to the token provider 302 and makes a token generation request to the token provider 302 (step S224). The token provider 302 acquires the secret key corresponding to the operation target device 100 from the key manager 301, signs the data received from the token receiver 204c, and returns the resulting data as the token to the token receiver 204c. When an abnormality occurs, e.g., when there is no key corresponding to the identifier of the operation target device 100, then the token provider 302 returns error information to the token receiver 204c. The token receiver 204c sends the data received from the token provider 302 to the token manager 203. The token manager 203 determines whether the token is generated normally (step S225). If the token is generated normally (Yes at step S225), the token manager 203 stores the token in a non-volatile area (step S226) and thereafter the process flow ends as a normal termination. If the token is riot generated normally (No at step S225), the process flow ends as an abnormal termination.

The third embodiment described above enables a function to generate the token to be provided only when the generation of the token is permitted by the business entity. As a result, it is difficult for a user to generate the token in an unauthorized manner and enjoy its benefits fraudulently in a use case where the operation target device being operated is advantageous to the user, thereby making it possible to protect the business entity operating the application information providing device 400 from being subject to unauthorized activities.

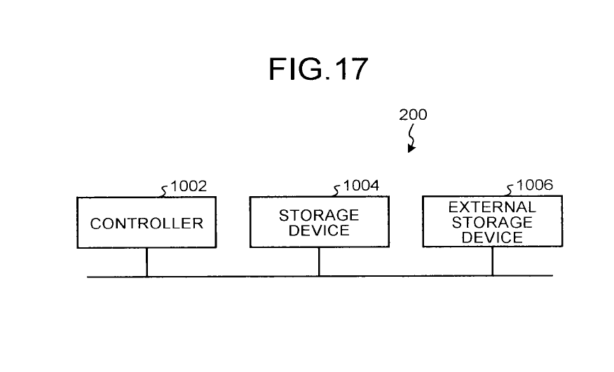

FIG. 17 is a schematic diagram illustrating an example of a hardware structure of the operation device 200 according to the embodiments and the modification described above. The operation device 200 includes a controller 1002 such as a central processing unit (CPU), a storage device 1004 such as a read only memory (ROM) or a random access memory (RAM), and an external storage device 1006 such as a hard disk drive (HOD), and can be achieved using a typical computer.

The processing executed by the operation device 200 according to the embodiments and the modification may be stored as a program. The program is stored in a computer-readable storage medium as a file in an installable or executable format, and provided. Examples of the computer-readable storage medium include a compact disc (CD)-ROM, a CD-recordable (CD-R), a memory card, a digital versatile disc (DVD) or a flexible disk (FD). The respective components of the operation device 200 may be achieved as hardware using an electronic circuit instead of the program.

The program executed by the operation device 200 may be stored in a computer connected to a network such as the Internet and provided by being downloaded through the network. Furthermore, the program executed by the operation device 200 may be provided or distributed through a network such as the Internet. The program executed by the operation device 200 may be embedded and provided in a ROM, for example.

The program executed by the operation device 200 has a module structure that achieves the components in a computer. In practical hardware, the CPU reads out the program from the HDD to the RAM so as to execute the program, so that the respective components can be achieved in the computer.

The embodiments are not limited to those described above. The embodiments can be embodied by changing components without departing from the spirit and scope of the embodiments when practiced. In addition, various aspects of the invention can be made by properly combining the components disclosed in the above embodiments. For example, some components may be eliminated from all of the components of the embodiments. Furthermore, the components of different embodiments may be properly combined.

For example, the steps in the flowcharts of the embodiments and the modification may be changed in execution order, some steps may be executed simultaneously, or the steps may be executed in different order for every implementation without departing from their roles.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
an application information reader to acquire identification information about an application capable of operating an operation target device;
an operation application executer to execute the application corresponding to the identification information;
a device information manager to perform authentication with the operation target device using authentication information, and store therein the authentication information when the authentication is successful;
a token manager to store therein a certificate that is issued for the operation target device and indicates a permission of the operation of the operation target device;
a token receiver to
request a token delivery device to generate the certificate corresponding to the authenticated operation target device, when the authentication by the device information manager is successful,
receive the generated certificate, and
store the generated certificate in the token manager; and
a transmitter to transmit, to the operation target device, a device operation instruction requested from the executed application, the authentication information acquired from the device information manager, and the certificate acquired from the token manager.

2. The device according to claim 1, further comprising an operation application receiver to acquire the application corresponding to the identification information acquired by the application information reader through a network, and send the acquired application to the operation application executer.

3. The device according to claim 2, further comprising a terminal information manager to store therein terminal information, which identifies a terminal from which the application information reader acquires the identification information, in association with the acquired identification information, wherein
the operation application executer acquires, from the terminal information manager, the terminal information being associated with the identification information and transmit the certificate to the terminal.

4. The processing device according to claim 2, wherein on the basis of the terminal information acquired from the terminal information manager, the token receiver inquires of the terminal about information indicating whether the generation of the certificate is permitted, and requests the token delivery device to generate the certificate when the generation of the certificate is permitted.

5. An information processing method, comprising:
acquiring identification information about an application capable of operating an operation target device;
executing the application corresponding to the identification information;
performing authentication with the operation target device using authentication information,
storing the authentication information when the authentication is successful;
requesting a token delivery device to generate a certificate when the authentication at the authenticating is successful, the certificate corresponding to the authenticated operation target device and indicating a permission of the operation of the operation target device;
receiving the generated certificate;
storing the generated certificate; and
transmitting, to the operation target device, a device operation instruction requested from the executed application, the stored authentication information, and the stored certificate.

6. A computer program product comprising a computer-readable medium containing a computer program, the computer program causing a computer to execute:
acquiring identification information about an application capable of operating an operation target device;
executing the application corresponding to the identification information;
performing authentication with the operation target device using authentication information, storing the authentication information when the authentication is successful;
requesting a token delivery device to generate a certificate when the authentication at the authenticating is successful, the certificate corresponding to the authenticated operation target device and indicating a permission of the operation of the operation target device;
receiving the generated certificate;
storing the generated certificate; and
transmitting, to the operation target device, a device operation instruction requested from the executed application, the stored authentication information, and the stored certificate.

7. An information processing system, comprising:
an operation target device that is to be operated.;
an operation device to operate the operation target device;
a token delivery device to generates a certificate that is issued for the operation target device and indicates a permission of the operation of the operation target device; and
an application information providing device to provide identification information about an application executed by the operation device, wherein
the operation device comprises:
an application information reader to acquire the identification information about the application capable of operating the operation target device from the application information providing device;
an operation application. executer to execute the application corresponding to the identification information;
a device information manager to perform authentication with the operation target device using authentication information, and store therein the authentication information when the authentication is successful;
a token manager to store therein the certificate acquired from the token delivery device;
a token receiver to
request the token delivery device to generate the certificate corresponding to the authenticated operation target device, when the authentication performed by the device information manager is successful,
receive the generated certificate, and
store the generated certificate in the token manager; and
an instruction transmitter to transmit, to the operation target device, a device operation instruction requested from the executed application, the authentication information acquired from the device information manager, and the certificate acquired from the token manager.
